(19) United States
(12) Patent Application Publication
(10) Pub. No.: US 2026/0321479 A1
(43) Pub. Date: Oct. 15, 2026

(54) SELF-COOLING MULTIFERROIC MAGNETIC MATERIAL FOR POWER CONVERSION

(71) Applicant: University of South Carolina, Columbia, SC (US)

(72) Inventors: Kristen Booth, Columbia, SC (US); Jacob Jones, Raleigh, NC (US); Todd Monson, Albuquerque, NM (US)

(21) Appl. No.: 19/644,705

(22) Filed: Apr. 10, 2026

Related U.S. Application Data
(60) Provisional application No. 63/786,400, filed on Apr. 10, 2025.

(51) Int. Cl. H01F 27/22; H01F 1/01; H01F 1/147; H01F 1/153; H01F 27/28; H01F 38/14; H02M 3/00

(52) U.S. Cl. CPC H01F 27/22; H01F 1/015; H01F 1/14716; H01F 1/15325; H01F 1/15333; H01F 27/2804; H01F 27/2895; H01F 38/14; H02M 3/003; H01F 27/2819

(57) ABSTRACT

This disclosure provides self-cooling multiferroic magnetic materials and devices for use in power conversion designs.

### CROSS-REFERENCE TO RELATED APPLICATIONS

This application is related to U.S. Provisional Patent Application No. 63/786,400, filed on Apr. 10, 2025, the entirety of which is incorporated by reference.

### BACKGROUND

With the increased switching capabilities of ultra-wide bandgap (UWBG) semiconductors, the passive components have become a known bottleneck in power conversion design. The passive components consistently require 25% to 40% of converter volume and a similar majority of the weight across all frequencies. These metrics include the mechanical housing and cooling structures, and some passive component designs have required complex active cooling systems which further reduce power density and increase weight (Moreno, G., et al., J. Electron. Packag. 2022, 144 (1), p. 011004). Passives, in general, need material-based redesign considerations to progress alongside the large innovations occurring in the semiconductor field; however, the scope of the present technology is limited to magnetic devices specifically for kilowatt power transfer at higher than conventional switching frequencies.

There are several demonstrative kilowatt power conversion studies in the 100s of kilohertz and into the megahertz frequency range based on these (U) WBG devices with the aforementioned limitations (Liu, Y.-F., et al., IEEE JESTPE 2023, 11 (3), pp. 2457-2468). The magnetic devices, assuming a ferrite composed of Manganese Zinc (MnZn) are limited by a peak operating temperature, approximately 100° C., that is 75° C. below the maximum junction temperature of the semiconductor. To add to the design complexity of the converter, these two components cannot create localized thermal interactions based on the fluid dynamics of the cooling mechanism(s), and the magnetic losses are regularly underestimated based on conductor AC and core loss mechanisms (Hu, J., et al., IEEE Trans. Power Electron. 2001, 16 (4), pp. 558-567). Traditional ferrite materials, even in laminated form, have extremely high losses due to domain polarization under high-frequency excitation which causes intrinsic thermal bottlenecks, as their relatively low thermal conductivities and internal heat dissipation limitations lead to elevated core temperatures.

The present technology enables magnetic component miniaturization by directly designing a self-cooling mechanism into the magnetic material to be used at higher excitation frequencies. This solid-state cooling is accomplished by integrating a multiferroic, either electrocaloric or magnetocaloric, material with a high flux density saturation material. The present disclosure provides a magnetic material which can be used for power transfer using UWBG semiconductors to increase power density.

### SUMMARY OF THE INVENTION

An inherent characteristic of increasing the frequency applied to a magnetic passive component is a reduction in magnetic volume. However, the commonly used ferrites may not be able to operate in the same temperature and frequency operating ranges alongside the current and next generation of wide bandgap and ultrawide bandgap semiconductors.

The present technology provides an unconventional and revolutionary magnetic device that can be miniaturized to be incorporated in megahertz power conversion designs. The underlying mechanism which allows a vast improvement from ferrite materials is the composition of nanocrystalline and multiferroic materials. The high saturation flux density of the nanocrystalline material enables the miniaturization, but it is known for extremely high losses which have historically limited its use to less than 10 kHz. However, the addition of either a magnetocaloric or electrocaloric material, as a layered or composite structure with the nanocrystalline, creates an opportunity for a new capability within the magnetic material: solid-state thermal management. Disclosed herein are the fundamental physics behind this capability alongside early development of a finite element analysis for the multiferroic-based magnetic device using Ansys® Icepak® (Ansys, Inc., Canonsburg, PA, USA), a specialized a Computational Fluid Dynamics (CFD) software for electronics thermal management, predicting airflow, temperature, and heat transfer in complex electronic systems. For example, this new core architecture achieves a more uniform device temperature and reduces the peak temperature of the device by at least 9° C. compared to conventional ferrite materials and structures.

In certain aspects, the present technology provides a self-cooling magnetic device for extracting heat from electromagnetic components, the self-cooling magnetic device comprising a soft multiferroic material (FIG. 2A) and a high electrical conductivity, non-magnetic material (e.g., copper (FIG. 2 B)), wherein the soft multiferroic material is laminated or synthesized with a high flux density saturation material, the self-cooling magnetic device having a multilayer structure comprising alternating layers of the laminated soft multiferroic material with layers of the high electrical conductivity, non-magnetic material (FIG. 2C).

In some embodiments, the soft multiferroic material is a soft magnetocaloric material, a soft electrocaloric material, or a combination thereof.

In some embodiments, including all the previous embodiments, the soft multiferroic material is a soft magnetocaloric material having a low permeability above room temperature and thermal conductivity of about 1 W/mK to about 25 W/mK.

In some embodiments, including all the previous embodiments, the soft multiferroic material is a soft magnetocaloric material selected from the group consisting of: Gadolinium (Gd) Gd alloys, rare-earth intermetallics, Manganese (Mn) alloys, and other transition metal alloys. In some embodiments, the soft multiferroic material is a soft electrocaloric material in the form of a thin film.

In some embodiments, including all the previous embodiments, the soft electrocaloric material has thermal conductivity of about 0.1 W/mK to about 5 W/mK.

In some embodiments, including all the previous embodiments, the soft multiferroic material is a soft electrocaloric material comprising thin films of a material comprising PbZr_{0.95}Ti_{0.05}O₃ [P(VDF-TrFE)], or P(VDF-TrFE-chlorofluoroethylene) P(VDF-TrFE-CFE)]. In some embodiments, including all the previous embodiments, the high flux density saturation material is a nanocrystalline or an amorphous alloy.

In some embodiments, including all the previous embodiments, the high flux density saturation material is a nanocrystalline material comprising a metal oxide or an iron alloy-based material. In some embodiments, the metal oxide is a titanium, zinc, or aluminum oxide. In some embodiments, the iron alloy-based material comprises Manganese (Mn), Cobalt (Co), Silicon (Si), Zinc (Zn), or a combination thereof.

In some embodiments, including all the previous embodiments, the high electrical conductivity and non-magnetic material is copper, aluminum, silver, titanium, gold, or an alloy thereof.

In some embodiments, including all the previous embodiments, the self-cooling magnetic device has a multilayer structure comprising at least two (2) alternated layers of the laminated soft multiferroic material per layer of the high electrical conductivity and non-magnetic material.

In some embodiments, the alternating layers of the laminated soft multiferroic material and the high electrical conductivity and non-magnetic material each has a thickness of about 0.1 μm to about 500 μm. In some embodiments, the alternating layers of the laminated soft multiferroic material and the high electrical conductivity and non-magnetic material each has a thickness of about 500 μm to about 5,000 μm.

In some embodiments, the alternating layers of the laminated soft multiferroic material and the high electrical conductivity and non-magnetic material each has a thickness of at least 10 μm. In some embodiments, the alternating layers of the laminated soft multiferroic material and the high electrical conductivity and non-magnetic material each has a thickness of at least 70 μm.

In some embodiments, including all the previous embodiments, the self-cooling magnetic device has efficient and uniformly distributed thermal characteristics matching a range of (Ultra) Wide Bandgap (UWBG) device temperature up to 175° C. In some embodiments, the self-cooling magnetic device has a peak temperature over 45° C.

In some embodiments, the soft multiferroic material is in the form of a composite, wherein a soft magnetic material is dispersed therethrough as a nanoparticle.

In some embodiments, the soft multiferroic material is a soft magnetocaloric material or a soft electrocaloric material.

In some embodiments, including all the previous embodiments, the soft magnetic material is selected from the group consisting of: iron alloy-based materials comprising Manganese (Mn), Cobalt (Co), Silicon (Si), Zinc (Zn), or a combination thereof, and iron nitrides (FeₓN), wherein x is 3 or 4.

In some embodiments, including all the previous embodiments, the soft multiferroic material is a soft magnetocaloric material having a low permeability above room temperature and a thermal conductivity of about 1 W/mK to about 25 W/mK.

In some embodiments, including all the previous embodiments, the soft multiferroic material is a soft magnetocaloric material selected from the group consisting of: Gadolinium (Gd), Gd alloys, rare-earth intermetallics, Manganese (Mn) alloys, and other transition metal alloys.

In some embodiments, including all the previous embodiments, the soft electrocaloric material has a thermal conductivity of about 0.1 W/mK to about 5 W/mK.

In some embodiments, including all the previous embodiments, the soft multiferroic material is a soft electrocaloric material comprising PbZr_{0.95}Ti_{0.05}O₃, poly(vinylidene fluoride-trifluoroethylene) [P(VDF-TrFE)], or P(VDF-TrFE-chlorofluoroethylene) P(VDF-TrFE-CFE)].

In some embodiments, including all the previous embodiments, the self-cooling magnetic device has efficient and uniformly distributed thermal characteristics matching a range of (Ultra) Wide Bandgap (UWBG) device temperature up to 175° C. In some embodiments, the self-cooling magnetic device has a peak temperature over 45° C.

In some other aspects, the present technology provides a self-cooling multiferroic inductor or a transformer, the self-cooling multiferroic inductor or transformer comprising: a core comprising the self-cooling magnetic device according to the present technology; and printed circuit board (PCB)-based or Litz windings inside the core.

In some embodiments, the self-cooling multiferroic inductor or transformer has toroidal or planar core shape. In some embodiments, the planar core shape is film-shaped.

In some embodiments, including all the previous embodiments, the PCB-based or Litz windings comprises copper windings, aluminum windings, silver windings, titanium windings, gold windings, or windings of an alloy thereof.

In some embodiments, including all the previous embodiments, the soft multiferroic material is a soft magnetocaloric material or a combination a soft magnetocaloric material and a soft electrocaloric material, and the soft magnetic material comprises particles of a magnetic and high permeability iron alloy. In some embodiments, the soft magnetic material is selected from the group consisting of: iron alloy-based materials comprising Manganese (Mn), Cobalt (Co), Silicon (Si), Zinc (Zn), or a combination thereof, and iron nitrides (FeₓN), wherein x is 3 or 4.

In some other aspects, the present technology provides a power electronics converter comprising the self-cooling multiferroic inductor according to the present technology.

In some embodiments, the power electronics converter has a switching frequency over 1 MHz and the output power of 1 kW.

In some embodiments, including all the previous embodiments, the power electronics converter has a switching frequency of about 10 MHz and the output power of 1 kW. Other embodiments are provided infra.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A-FIG. 1B provides an illustration of a state-of-the-art magnetic device extracting heat from an electronic device and a corresponding thermal image.

FIG. 1A an illustration of a state-of-the-art magnetic device extracting heat from an electronic device.

FIG. 1B is a thermal image showing heat being extracted from a current state-of-the-art magnetic device through the basic properties of thermodynamics.

FIG. 2A-FIG. 2C provide a set of illustrations of the components and a cross section of a simplified laminated structure of a multiferroic device according to the present technology.

FIG. 2A is an illustration of the simplified laminated structure of the multiferroic material displaying the core material laminated structure.

FIG. 2B is an illustration the single turn of copper in the material.

FIG. 2C is an illustration of a cross section of the complete magnetic device.

FIG. 3 provides an illustration of an exemplary hot-pressed material for a composite structure according to the present structure, as described in Hoyt, M. R., et al., Front. Mater. 2023, 10, 1258382.

FIG. 4 provides a schematic of an exemplary caloric cooling cycle, as described in Takeuchi, I. and K. Sandeman, K., Phys. Today 2015, 68 (12), pp. 48-54.

FIG. 5A-FIG. 5B provide a set of illustrations of the design structures (e.g., composite structure or layered structure) and the types (e.g., electrocaloric or magnetocaloric material) of multiferroic material according to the present technology.

FIG. 5A is an illustration of an electrocaloric layered structure and a magnetocaloric layered structure of the self-cooling, multiferroic material according to the present technology, showing solid-state cooling through the use of existing electromagnetic fields within the magnetic component.

FIG. 5B is a set of illustrations of a magnetocaloric composite structure of the self-cooling, multiferroic material according to the present technology, showing the magnetocaloric cycle is displayed for one quarter of an applied current period where the magnetic material domain orientations are represented by the gray ovals and arrows.

FIG. 6A-FIG. 6B provides a set of diagrams of flux density, B (T), and current density, J (A/cm²), obtained by Finite Element Analysis (FEA) simulation of the self-cooling, multiferroic material according to the present technology.

FIG. 6A is a diagram of flux density, B (T), of the self-cooling, multiferroic material according to the present technology.

FIG. 6B is a diagram of current density, J (A/cm²), of the self-cooling, multiferroic material according to the present technology.

FIG. 7A-FIG. 7B provides a set of diagrams of flux density, B (T), and current density, J (A/cm²), obtained by FEA simulation of a comparative ferrite-based material.

FIG. 7A is a diagram of flux density, B (T), of the comparative ferrite-based material.

FIG. 7B is a diagram of current density, J (A/cm²), of the comparative ferrite-based material.

FIG. 8A-FIG. 8B provide a set of thermal images of proposed magnetic structure for the self-cooling, multiferroic material according to the present technology and the comparative ferrite-based material.

FIG. 8A is a thermal image of proposed magnetic structure for the self-cooling, multiferroic material according to the present technology.

FIG. 8B is thermal image of proposed magnetic structure for the comparative ferrite-based material.

FIG. 9 provides an illustration of an exemplary multiferroic racetrack-style inductor according to the present technology.

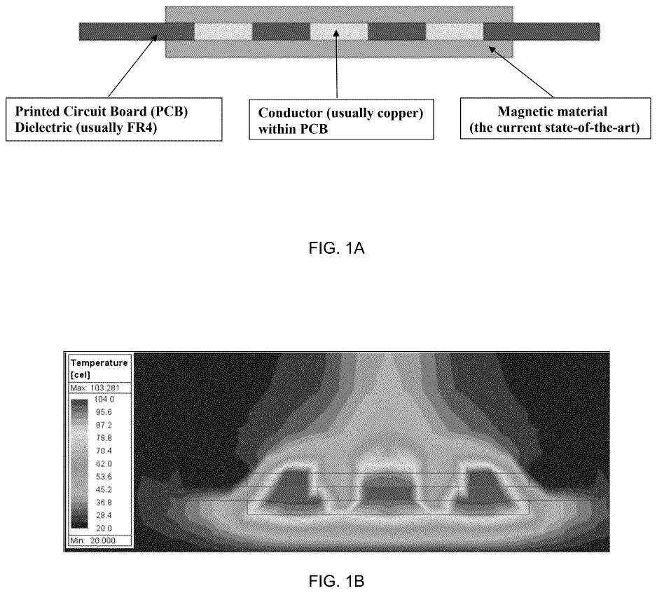

### DETAILED DESCRIPTION

Provided herein are self-cooling multiferroic magnetic devices for use in megahertz power conversion designs, for example, self-cooling magnetic materials/devices for extracting heat from electromagnetic components, self-cooling multiferroic inductors comprising self-cooling magnetic devices according to the present technology, and power electronics converter comprising a self-cooling multiferroic inductor according to the present technology.

### Definitions

Unless stated otherwise, the following terms and phrases as used herein are intended to have the following meanings:

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

Unless otherwise defined, all terms (including technical and scientific terms) are to be given their ordinary and customary meaning to a person of ordinary skill in the art and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the present disclosure, but instead as merely intended to highlight alternative or additional features that may or may not be utilized in a particular embodiment of the present disclosure.

Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments. For instance, when a plurality of ranges is provided, any combination of a minimum value and a maximum value described in the plurality of ranges are contemplated by the present disclosure. For example, if ranges of ‘from about 20% to about 80%’ and ‘from about 30% to about 70%’ are described, a range of ‘from about 20% to about 70%’ or a range of ‘from about 30% to about 80%’ are also contemplated by the present disclosure. Unless otherwise clear from the disclosure, recitation of “about” prior to a first value in a range is understood to modify both ends of the range.

With respect to the use of substantially any plural or singular terms herein, those having skill in the art can translate from the plural to the singular or from the singular to the plural as is appropriate to the context and/or application. The various singular/plural permutations may be expressly set forth herein for sake of clarity. The indefinite article ‘a’ or ‘an’ does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ‘at least one’ and ‘one or more’ to introduce claim recitations. However, the use of such phrases should not be construed to imply that the introduction of a claim recitation by the indefinite articles ‘a’ or ‘an’ limits any particular claim containing such introduced claim recitation to embodiments containing only one such recitation, even when the same claim includes the introductory phrases ‘one or more” or ‘at least one’ and indefinite articles such as ‘a’ or ‘an’ (e.g., ‘a’ and/or ‘an’ should typically be interpreted to mean ‘at least one’ or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of ‘two recitations,’ without other modifiers, typically means at least two recitations, or two or more recitations). Furthermore, in those instances where a convention analogous to ‘at least one of A, B, and C, etc.’ is used, in general such a construction is intended in the sense one having skill in the art would understand the convention (e.g., ‘a system having at least one of A, B, and C’ would include but not be limited to systems that have A alone, B alone, C alone, A and B together, A and C together, B and C together, and/or A, B, and C together, etc.). In those instances where a convention analogous to ‘at least one of A, B, or C, etc.’ is used, in general such a construction is intended in the sense one having skill in the art would understand the convention (e.g., ‘a system having at least one of A, B, or C’ would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase ‘A or B’ will be understood to include the possibilities of ‘A’ or ‘B’ or ‘A and B.’

All numbers expressing quantities of ingredients, reaction conditions, and so forth used in the specification are to be understood as being modified in all instances by the terms ‘about,’ ‘approximately,’ or ‘generally.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

As used herein, the terms ‘about,’ ‘approximately,’ or ‘generally,’ when used to modify a value, indicate that the value can typically be raised or lowered by 5% and remain within the disclosed embodiment. The term “about” or “approximately” means an acceptable error for a particular value as determined by one of ordinary skill in the art, which depends in part on how the value is measured or determined, or a degree of variation that does not substantially affect the properties of the described subject matter, or within the tolerances accepted in the art, e.g., within 10%, 5%, 2%, or 1%, or within two standard deviations of a set of values. Accordingly, unless indicated to the contrary, the numerical parameters set forth in the following specification and attached claims are approximations that may vary depending upon the desired properties sought to be obtained. When “about” is present before the first value of a series, it is understood to modify each value in the series.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole. With respect to the terms “comprising” and “consisting of” where one of these terms is used herein, the presently disclosed and claimed subject matter can include the use of the other term.

As used herein, the term “multiferroic material” refers to a material possessing at least two long-range ferroic orderings (ferromagnetic or antiferromagnetic, ferroelectric, and ferroelastic) simultaneously in a single phase. Ferromagnetism refers to a magnetization that is switchable by an applied magnetic field; ferroelectricity refers to an electric polarization that is switchable by an applied electric field; and ferroelasticity refers a deformation that is switchable by an applied stress. Multiferroic materials are characterized by the coexistence of these ordered states, which enable multifunctional electronic applications within a single solid-state element. Exemplary, multiferroic materials according to the present technology comprises materials such as PbZr_{0.95}Ti_{0.05}O₃, poly(vinylidene fluoride-trifluoroethylene) [P(VDF-TrFE)], or P(VDF-TrFE-chlorofluoroethylene) P(VDF-TrFE-CFE)].

As used herein, the term “magnetocaloric material” refers to a material that heats up and cool downs when exposed to a changing magnetic field, a phenomenon known as the magnetocaloric effect (MCE). The essence of conventional MCE is the following: when the magnetic field increases, the degree of magnetic order in the ensemble of magnetic moments increases, the ensemble of stochastically moving magnetic moments loses its energy, this energy cannot disappear, and therefore, transfers to the crystal lattice and heats it; and when the field decreases, the stochastic motion of magnetic moments appears again by taking energy from the lattice, whereby cooling it. Exemplary magnetocaloric materials according to the present disclosure include Gadolinium (Gd) and Gd alloys.

As used herein, the term “electrocaloric material” refers to a material that reversibly changes temperature when an electric field is applied or removed, heating up when the field is applied and cooling down when the field is removed. The described phenomenon is known as the electrocaloric effect (ECE). Exemplary electrocaloric materials according to the present disclosure include PbZr_{0.95}Ti_{0.05}O₃, [P(VDF-TrFE)], or P(VDF-TrFE-CFE)].

As used herein, the term “nanoparticle” refers to a particulate material having a particle size in the range of about 1 nm to about 500 nm. In some embodiments, nanoparticles according to the present disclosure have a particle size in the range of about 1 nm to about 100 nm. In some embodiments, the multiferroic material according to the present technology is in the form of a composite, wherein a soft magnetic material is dispersed as a nanoparticle throughout the magnetocaloric or electrocaloric material.

As used herein, the term “transition metal alloys” refers to metallic magnetocaloric materials composed of two or more elements of which at least one being a d-block element. Commonly used transition metals include titanium (Ti), vanadium (V), chromium (Cr), manganese (Mn), iron (Fe), cobalt (Co), nickel (Ni), copper (Cu), and noble metals like platinum (Pt) and palladium (Pd). Exemplary transition metal alloys according to the present disclosure include Mn, Fe, Co, and Ni alloys (e.g., CoFe₂O₄, TbMn₂O₅, LuFe₂O₄, and BiFeO₃).

As used herein, the term “rare-earth intermetallics” refers to a unique class of magnetocaloric materials formed by combining rare-earth elements (i.e., lanthanides, scandium, and yttrium) with other metals, most notably 3d transition metals like iron (Fe), cobalt (Co), and nickel (Ni). Lanthanides refer to the 15 elements with atomic numbers from 57 to 71. Rare-earth intermetallics are critical for high-performance magnets (e.g., Nd₂Fe₁₄B and SmCo₅), advanced electronics, and energy technologies due to their unique magnetic anisotropy, high Curie temperatures, and substantial saturation. Other exemplary rare-earth intermetallics include Sm₂Co₁₇, Terfenol-DR, GdsSi₂Ge₂, CeCos, and rare earth-magnesium alloys.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Reference will now be made in detail to certain embodiments of the invention, examples of which are illustrated in the accompanying drawings. While the invention is described in conjunction with the illustrated embodiments, it will be understood that they are not intended to limit the invention to those embodiments. On the contrary, the invention is intended to cover all alternatives, modifications, and equivalents, which may be included within the invention as defined by the appended claims and included embodiments.

The design methodology of soft magnetic materials for ultra-high frequency operation is vitally important to enable more efficient transportation. The material search space and ultimate selection must be justified for the specific needs of electrified transportation to include operating conditions and potentially extreme environments. This approach requires a co-simulation of integrated materials and leads to a converter-level codesign to enable optimal performance of the developed inductor. Similar to the design innovations required to transition from silicon (Si) to silicon carbide (SiC) devices in the late 2000s, ultra-high frequency magnetics cannot simply replace existing components, but ultimately, the entire design should be reconsidered to enhance utilization of ultra-high frequency magnetic components (Wang, G., et al., 2010 IEEE Energy Conversion Congress and Exposition, Atlanta, GA, USA, 2010, pp. 100-104).

The efficiency of electrified transportation is not measured by power conversion efficiency alone. Consumers desire the ability to travel long distances on a single charge, and the empty weight of the vehicle (the weight before adding people or cargo) has a large impact on the available travel distance. Current power conversion on electrified transportation is managed with lower voltages (i.e., 12 V, 48 V, up to 400 V) with switching frequencies in the 10s to 100 kHz. At these frequencies, the reactive components of the power converters require over 50% of the converter volume and weight (Burkart, R. M. and Kolar, J. W., IEEE 14th Workshop on Control and Modeling for Power Electronics (COMPEL), 2013). By increasing the switching frequency above 1 MHz, these components can be smaller which greatly enhances the power density of the converter. Unfortunately, ferrite magnetics, which are used in state-of-the-art power converters, are incapable of these ultra-high frequencies and operating temperatures due to permeability and Curie temperature limitations (“Soft ferrites and accessories,” https://www.ferroxcube.com/en-global/download/download/11). Therefore, the present technology provides a new magnetic material through a revolutionary design paradigm for ultra-high frequency applications in extreme environments. Specifically, the present technology provides a radically different magnetic material structure that enables device self-cooling and increased operating temperatures, high power density, and resistance to mechanical stresses. The unique self-cooling mechanism to remove the naturally occurring waste heat is especially important given the reduced surface area of ultra-high frequency devices. That is, according the present technology, the magnetic material can be tuned to fit converter specifications and requirements.

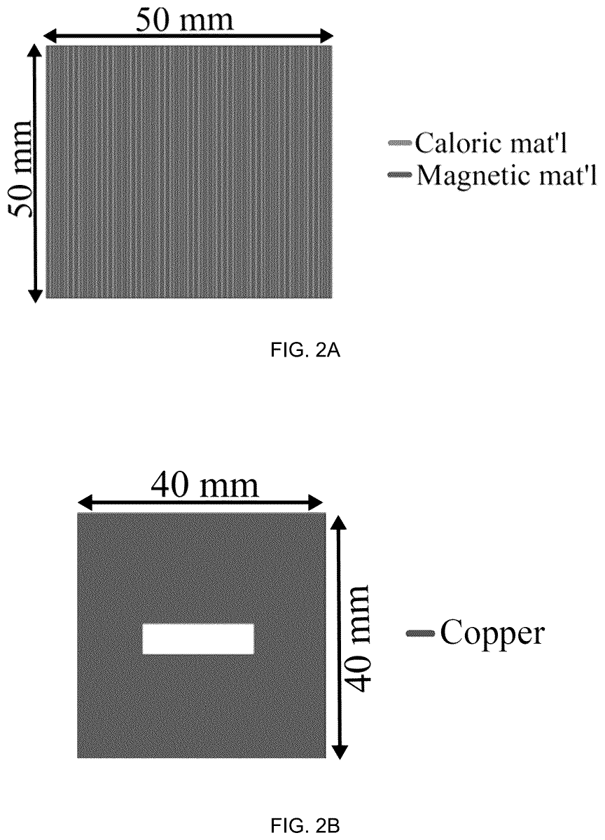

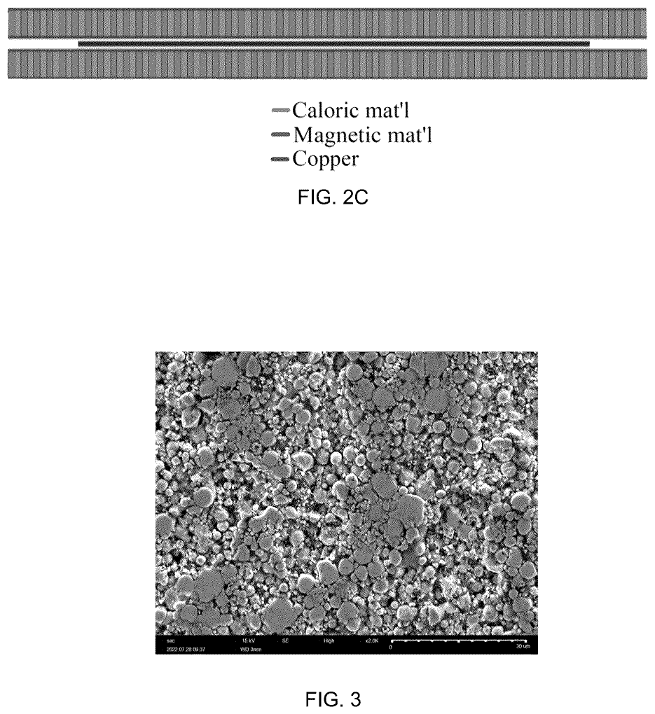

The present technology also provides improved electronic components and devices (e.g., self-cooling multiferroic inductors, power converters) by replacing current magnetic materials with a new revolutionary material (e.g., the self-cooling multiferroic material disclosed herein) which can operate in ultra-high frequencies while providing the same power transmission that is available today. Enabled by higher frequencies, the necessary volume of the magnetic material is drastically reduced which then reduces the size of the overall power converter. The multiferroic material according to the present technology has a high enough saturation flux density that it can be used simply as a film overlaid onto the copper traces of a Printed Circuit Board (PCB) or designed like a pressed powder core. The designed multiferroic, soft magnetic material removes heat from an electronic device through the normal mechanisms intrinsic to magnetic components, as shown in FIG. 2A, FIG. 2B, and FIG. 2C. This drastic change to the magnetic design reduces the general rule of thumb of magnetic volume in a converter from 30% to less than 5%. To prepare for the required heat dissipation of the reduced volume in higher ambient operating temperatures, the device itself uses the same electromagnetic fields to store energy to also expel heat via a heat pump mechanism in the material. At these ultra-high frequencies, the (ultra) wide bandgap ((U) WBG) semiconductors will also be more fully utilized to their potential switching speed limits.

The current state-of-the-art high frequency soft magnetic materials are ferrites whose relative permeability falls off sharply above 1 MHz (Silveyra, J. M., et al., Science 2018, 36 (6413), p. eaao0195; He, J., et al., Mater. Today Electron. 2023, 6, 100066). There are very few materials which can handle frequencies beyond 3 MHz. At these frequencies, the operating temperatures are limited due to the power loss density of the material when compared to (U) WBG device limits (“Soft ferrites and accessories,” https://www.ferroxcube.com/en-global/download/download/11). Commercial-Off-The-Shelf (COTS) magnetic cores are generally developed using a powder which are either sintered or hot pressed into a specific shape (“Ferrite vs. pressed powder-core inductors,” https://www.coilcraft.com/getmedia/5196d074-40d5-4f53-ac0b-bf458214187d/Doc1733Ferrite Vs Composite.pdf). The heat treatment of ferrite cores creates a very brittle structure, which easily break or chip with minimal shock or vibration, while the pressed-powder cores can exhibit better resistance to shock and vibration. However, pressed-powder cores suffer from lower permeability as compared to ferrites. Also, COTS magnetic materials have limited operating temperatures and are tuned for operating around 100-120° C. while the semiconductors and other components have operating temperatures which can extend up to 200° C. Magnetic devices do not function in isolation, especially in power-dense converters, so the heated enclosure of the system due to the losses in the power components and auxiliary circuits must be considered, making elevated temperature operation for magnetics necessary. From a comparison of the state-of-the-art to the present technology, the following differences can be defined:
a) The present technology provides a multiferroic material and device which can enable megahertz and kilowatt power conversion for harsh environments.
b) The present technology utilizes an integrated caloric material to extract heat from magnetic components, including the Printed Circuit Boards (PCBs) or windings.
c) The present technology revolutionizes power electronics design for ultra-high frequencies at increased power to better incorporate the multiferroic material and UWBG and WBG semiconductors.

### Multiferroic Material Meets Magnetic Theory

The miniaturized magnetic device is considered to be a Printed Circuit Board (PCB)-based structure in this initial design, as shown in FIG. 2A-FIG. 2C. The multiferroic material is considered to be a thin film overlaid onto the top and bottom of the PCB, as shown in FIG. 2C, with a high saturation flux density magnetic material layered with a multiferroic material for solid-state cooling.

The multiferroic material can also be prepared as a composite design according to the present technology. For the composite design, the soft magnetic material is dispersed as a nanoparticle throughout the magnetocaloric or electrocaloric material. The multiferroic composite stack is built up, this time by alternating layers of spin coated amorphous alloy nanoparticles, e.g., as shown in FIG. 3, and the multiferroic polymer. The advantage of this synthesis method is the increased magnetic material surface area of the nanoparticles, which increases heat removal from the magnetic material and improves shock resilience over a layered structure, as demonstrated below.

### A. Desired Magnetic Properties

To fully define the interactions between the solid-state cooling and the magnetic device specifications, it is valuable to review magnetic theory (Umans, S. D., Fitzgerald Kingsley's Electric Machinery, McGraw-Hill Companies, 2020). Beginning with a 2-dimensional symmetric study of miniaturized magnetic device in FIG. 2A-FIG. 2C and Ampere's Law

[symbol]

\vec{B}· [symbol] =μ₀Iₑₙₑ: (1)

Where \vec{B} is the developed flux density within a closed Amperian loop, [symbol] is a small length element along the path, μ₀ is the permeability of free space, and Iₑₙₑ is the summation of the current passing through any surface bounded by the closed path, then the resulting Magnetic Equivalent Circuit is

$$\text{?} = {I}_{enc} = \frac{ϕ}{2} ( {\text{?}}_{mag} + {\text{?}}_{cal} + {\text{?}}_{g} ) \qquad ( 2 )$$

Where [symbol] is the magnetomotive force, φ=BA_{c} is the developed magnetic flux equal to the flux density multiplied by the cross-sectional area, A_{c}, normal to the flux, and [symbol] is the reluctance of the magnetic material, caloric material, and the air gaps, respectively. With reluctance proportional to the summation of the total length of each material, [symbol] , defined as

$$\text{?} = \frac{{ℓ}_{x}}{{μ}_{0} {μ}_{r , x} {A}_{c}} , \qquad ( 3 )$$

and the relative permeability, μ_{r,x}, of each material, then the layered structure creates two parallel branches of reluctance in the magnetic material. Assuming the magnetic material has a much higher relative permeability than the parallel branch of the caloric material, the flux is assumed to be contained in the magnetic material layers, and the reluctance of the magnetic structure approaches zero. Hence, the total reluctance can be reduced to the reluctance of the air gap as in conventional magnetic components. These calculations must also incorporate divergence theorem to include the variations in cross-sectional areas throughout the magnetic structure.

The resulting inductance, L, can be calculated as

$$L = \frac{{n}^{2}}{\text{?}} . \qquad ( 4 )$$

With n as the number of turns and the reluctance of the air gaps internal and external to the enclosed current, there is no reduction in the inductance that can be developed in a multiferroic material with a vastly reduced cross-sectional area within the multiferroic material and, therefore, an overall drastic increase in power density compared to conventional designs. The reluctance of the air gaps can also be reduced by allowing the magnetic material to fill the entire width of the PCB beyond the copper traces driving the enclosed current. The low permeability inside the Amperian loop also reduces fringing effects at the inner air gap, thereby reducing the impact of AC winding resistance loss (Yang, R. S., et al., IEEE Trans. Power Electron. 2019, 34 (10), pp. 9993-10005).

### B. Solid-State Cooling Desired Properties

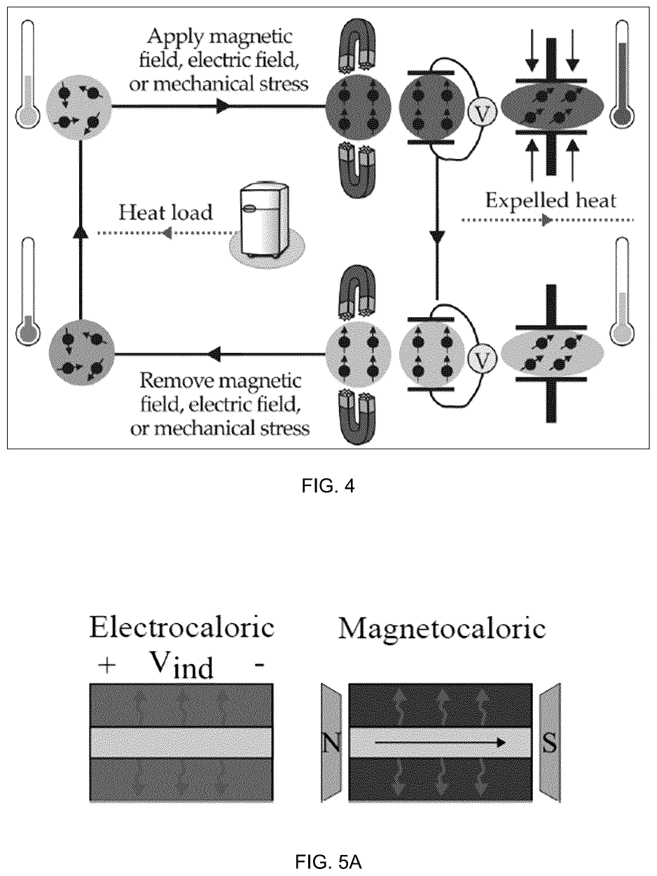

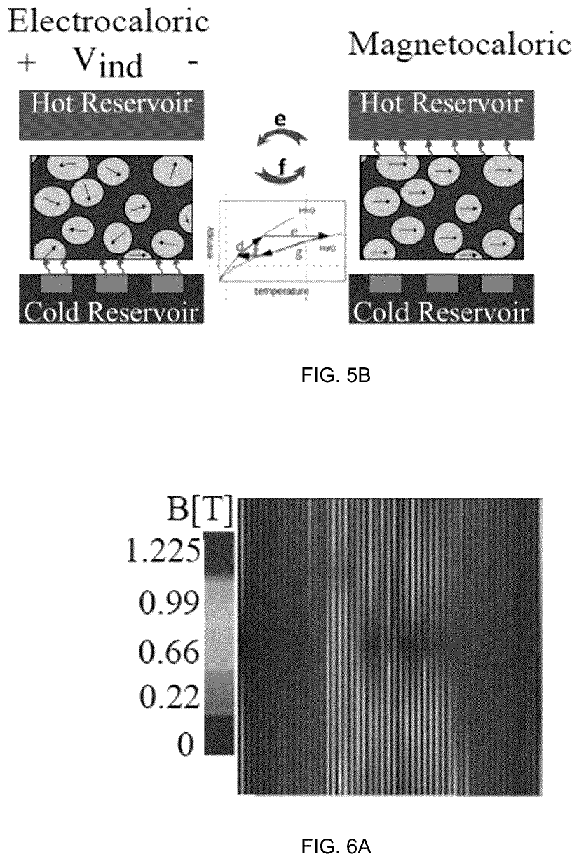

With the magnetic device considerations and the basic assumptions remaining valid, the thermal impact of an interspersed caloric material is presented herein. The intentional design of a thermal management system using a caloric material is the point of emphasis for the present technology. A caloric material can use an applied field, such as an induced electric or magnetic field, to drive a cooling cycle similar to the one in FIG. 4. An applied field allows the material to expel heat, and a relaxed field brings it back to a neutral state (Law, J. L., et al., J. Appl. Phys. 2023, 133 (4), 040903; Kitanovski, A., Adv. Energy Mater. 2020, 10, 1903741; Liu, X., Nat. Commun. 2023, 14, 4811). This cyclic process enables consistent heat extraction as the domains are aligned within the magnetic material, as shown in FIG. 5A-FIG. 5B.

For a magnetocaloric operation within the multiferroic structure, the same time-varying magnetic fields which enable energy storage can also enable the cooling-loop operation. A simple conversion to an electrocaloric material as a solid-state cooling mechanism can be readily understood via the Poynting vector, expressed as

$$\vec{S} = \frac{1}{μ} \vec{E} \times \vec{B} , \qquad ( 5 )$$

to highlight that the energy which can be used for an electrocaloric material has an orthogonal and equal relationship to the magnetic field associated with the developed electromagnetic wave.

### Self-Cooling Multiferroic Material/Multiferroic Magnetics

For the purposes of further describing the capabilities of a multiferroic magnetic device structure according to the present technology (e.g., as illustrated in FIG. 2A-FIG. 2C), a simplified example structure and simulation (using Finite Element Analysis (FEA) simulation) were developed based on materials which exhibited desirable characteristics for a magnetocaloric based solid-state cooled magnetic device. These materials, nor sizing thereof, were not optimized or meant to be all inclusive of potential materials which can be used instead.

Based on the desired miniaturization, the magnetic material is nanocrystalline with a high saturation flux density of 1.2 T. The simulation was operated well below the megahertz design space due to extremely high eddy current losses in laminated cores. For the disclosed simulation, the core loss and hysteresis data at 100 kHz was extracted from a datasheet (Magnetics, Inc., “Magnetics—supplier of precision soft magnetic components,” 2025, https://www.mag-inc.com/).

The magnetocaloric material layer is gadolinium (Gd), which has a low permeability above room temperature and a high thermal conductivity of approximately 10.6 W/mK. The Curie temperature, 20° C., and magnetocaloric properties of Gd enabled it to dynamically interact with changing magnetic fields to assist in internal thermal management (Scheunert, G., et al., Applied Physics Letters 2012, 101 (14), p. 142407). Gd alloys may also be used as the magnetocaloric material layer. These characteristics enable the solid-state cooling characteristics desired for the magnetic device. By using this multiferroic layered structure, this design provides the ability to lower peak core temperatures, reduce hot spots, and minimize the demand for external active cooling, thereby enabling higher power density designs in advanced power electronics.

The final component of the magnetic device is the conductor, which, in this case, was assumed to be a PCB-based winding; therefore, all distances between the magnetic material and copper trace were assumed to be the thickness of a generic 2-layer PCB. The conductor loop is meant to represent a copper trace that comes from one or more components of the power converter to another component. In some embodiments, the alternating layers of the laminated soft multiferroic material and the high electrical conductivity and non-magnetic material according to the present technology (i.e., the conductor) each has a thickness of at least 70 μm. The thickness of the high electrical conductivity and non-magnetic material can be increased or decreased depending on structure of the magnetic device. In some embodiments, the multiferroic material is pressed around the electrical conductor, made into a planar core structure, or layered on each side of the conductor (PCB-based). The conductor, in some embodiments, comprises Litz windings.

The final magnetic device structure for the simulation is provided in FIG. 2A-FIG. 2C, and Table I, below, outlines the structural parameters used. The structure consists of alternating layers of a magnetic material and a caloric material. A sinusoidal current excitation of 15 Arms at 100 kHz is applied in all simulations due to the size of the layers of the materials.

TABLE I
STRUCTURAL PARAMETERS
OF HYBRID MAGNETIC CORE

| Parameter | Value | |
|---|---|---|
| Ferrite (3C98) thickness | 0.5 | mm |
| Ferrite (3C98) width | 0.5 | mm |
| Nanocrystalline thickness | 0.5 | mm |
| Nanocrystalline width | 0.5 | mm |
| Gadolinium (Gd) thickness | 0.5 | mm |
| Gadolinium (Gd) width | 0.5 | mm |
| Copper thickness | 2 oz (70 μm) | |
| Copper width | 40 | mm |

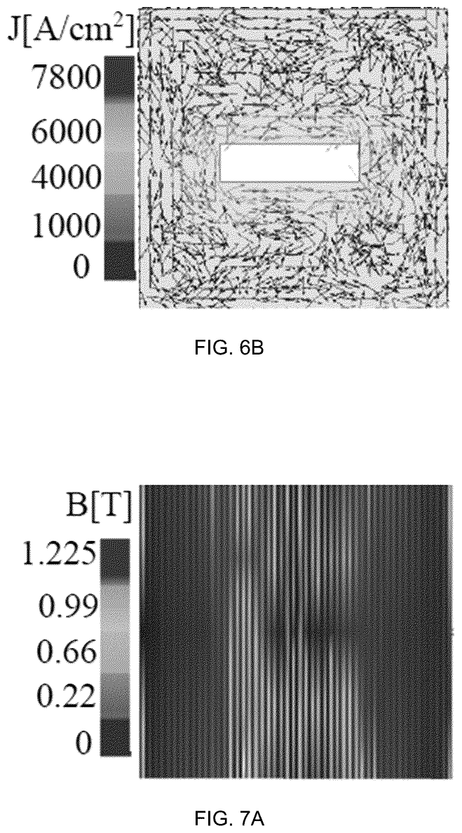

Respectively, FIG. 6A and FIG. 6B illustrate magnetic flux density, B, and current density, J, distributions for the proposed multiferroic magnetic device based on FEA. The device operated as expected from the theoretical discussion of “Desired Magnetic Properties” (above), and the nanocrystalline material exhibited high B in its layers. It is important to note that while the magnetic flux density, B, is not uniform in each layer, the 2-dimensional assumption of uniform flux density is valid for each individual layer.

The multiferroic material did not develop a magnetic field above the vertical legs of the current trace due to the orientation of the layers, and this outcome aligns with magnetic devices whose conductors extend beyond the core material. The outcome was a magnetic device that does not need long trace lengths nor vast amounts of magnetic material to develop the needed electrical parameters for power conversion. If an orthogonal conductor is covered by a layered film of the material, then the magnetic device can be made with the length of the trace required for the inductance and distance between the surrounding components of the larger system. The simulated results developed an inductance of 1 μH, and the 2-dimensional analytical model agrees with a low percent error of 0.56%.

The experimental tests showed that the multiferroic material had a peak temperature of 44° C. See, Table II in Example 2, below. The decrease in peak temperature is linked to the enhanced capacity of the multiferroic material to distribute heat more uniformly across the self-cooling device, as described by the present technology. The peak temperature of a multiferroic material according to the present technology can be tuned by adding, for example, more cobalt (Co) to the composition to slightly adjust its material properties for a specific application.

Accordingly, in some other aspects, the present technology provides a self-cooling multiferroic inductor, the self-cooling multiferroic inductor comprising: a core comprising the self-cooling magnetic device according to the present technology; and printed circuit board (PCB)-based or Litz windings inside the core.

In some embodiments, the self-cooling multiferroic inductor has toroidal or planar core shape. In some embodiments, the planar core shape is film-shaped.

In some embodiments, the PCB-based or Litz windings comprises copper windings, aluminum windings, silver windings, titanium windings, gold windings, or windings of an alloy thereof.

In some embodiments, the soft multiferroic material is a soft magnetocaloric material or a combination a soft magnetocaloric material and a soft electrocaloric material, and the soft magnetic material comprises particles of a magnetic and high permeability iron alloy. In some embodiments, the soft magnetic material is selected from the group consisting of: rare-earth intermetallics, Manganese (Mn) alloys, and other transition metal alloys, and iron nitrides (FeₓN), wherein x is 3 or 4.

In some embodiments, inductors according to the present technology are designed as racetrack-style inductors, as described in Harburg, D. V., et al., IEEE JESTPE 2018, 6 (3), pp. 1280-1294.

### Multiferroic Device-Integrated Power Electronics

In some further aspects, the present technology provides a power electronics converter comprising the self-cooling multiferroic inductor according to the present technology. The magnetic material, design, and self-cooling multiferroic inductor according to the present technology are codesigned and co-simulated with the converter to enable component- and system-level improvements. By increasing the switching frequency above 1 MHz, these components can be smaller which greatly enhances the power density of the converter.

In some embodiments, the power electronics converter has a switching frequency over 500 KHz and output power from 10s mW to 100s kW. In some embodiments, the power electronics converter has a switching frequency of about 10 MHz and the output power of 1 kW.

Lightweight power conversion devices according to the present technology can reduce the work required to move passengers or cargo by reducing the empty weight of the mode of transportation. Devices according to the present technology are expected to be deployed in electric vehicles (including heavy duty and agricultural vehicles) given their projected exponential market growth, followed by electric naval and aerospace applications (International Energy Agency, “Trends in Electric Cars,” https://www.iea.org/reports/global-ev-outlook-2024/trends-in-electric-cars).

### EXAMPLES

The following examples are included to demonstrate preferred embodiments of the technology. However, those of skill in the art should, in light of the present disclosure, appreciate that many changes can be made in the specific embodiments which are disclosed and still obtain a like or similar result without departing from the spirit and scope of the technology.

### Example 1: Materials Synthesis

The magnetic components and ultra-wide bandgap (UWBG) semiconductors must cooperate with each other to improve the performance of high power, higher switching frequency converters. The co-simulation and codesign of the multiferroic, soft magnetic material and the power electronics converter is vital to determining the desired material properties. Using the computational method Finite Element Analysis (FEA), ANSYS® Electronics Desktop™, a unified simulation platform for designing and analyzing electromagnetic, circuit, and system-level performance in a single interface, was used to study the multiferroic, soft magnetic material candidates at the material properties level (ANSYS® Material Designer), the magnetic component design (ANSYS Maxwell), the thermal properties (ANSYS® Icepak®), the electromagnetic properties and potential for radiated and conducted electromagnetic interference (locally in ANSYS® SIWave® and converter-level via ANSYS® HFSS™), and the integration of the magnetic device to the converter (ANSYS® Simplorer®). As one software of the co-simulation was updated, its outputs were synced to the other softwares to show the impact of the design modification to the other aspects being co-simulated. By integrating the various levels of the magnetics-to-converter design, the technical pathways were explored prior to synthesizing the material, and the models were used for tuning the material properties, the magnetic device, and the converter overtime, such as in Wu, T., et al., IEEE Trans. Power Electron. 2019, 3 (6), pp. 5027-5031; Hoyt, M. R., et al., Front. Mater. 2023, 10, 1258382); “Introduction to pexpert,” https://www.ansys.com/training-center/course-catalog/electronics/introduction-to-ansys-pexprt; Booth, K., et al, JESTPE 2020, 9 (4), pp. 5097-5112).

An exemplary magnetic device structure from the simulations is provided in FIG. 2A-FIG. 2C, and Table I, above, outlines the structural parameters used. FIG. 6A and FIG. 6B illustrate magnetic flux density, B, and current density, J, distributions for the proposed multiferroic magnetic device based on FEA, respectively.

Materials, structures, and types simulated were synthesized for comparison to the simulated results. These early-stage design activities are necessary prior to integration with device fabrication to understand the scaling for manufacturing, materials properties, and material interactions required for device fabrication.

### Example 2. Multiferroic Material According to the Present Technology Vs. Ferrite-Based Material

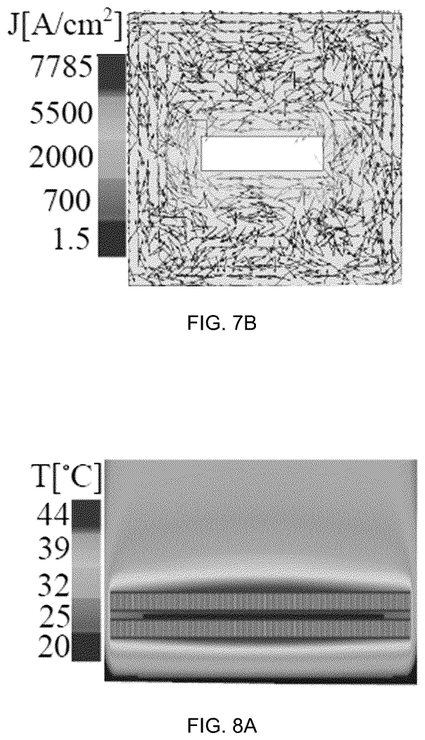

In order to demonstrate the thermal improvements of an integrated caloric material, the simulated caloric material was replaced by a ferrite material, with datasheet information, for comparison (Ferroxcube, “Ferroxcube—global leader in high performance ferrite,” https://www.ferroxcube.com/en-global). The same quantities for the comparative case are shown in FIG. 7A and FIG. 7B. As in the multiferroic simulation, the flux concentrates in the center of the magnetic core while current crowding is observed near the inner conductor boundaries. The simulated losses can be found in Table II.

TABLE II
COMPARISON OF THE MAGNETIC DEVICE RESULTS

| | | |
|---|---|---|
| Quantity | Multiferroic | Comparator |

| | | | | |
|---|---|---|---|---|
| Core Loss | 0.5001 | W | 0.5277 | W |
| Copper Loss | 1.162 | W | 1.162 | W |
| Peak Temperature | 44 | °C | 53 | °C |
| Average Temperature | 40 | °C | 43 | °C |

Because the magnetic field is time and location dependent due to the material boundaries, the instantaneous difference allows the magnetocaloric material, Gd, to extract heat from the system. The multiferroic material enhances the magnetic component by improving the efficiency of the device, and this early development highlights the possibilities with a tuned multiferroic material for this application.

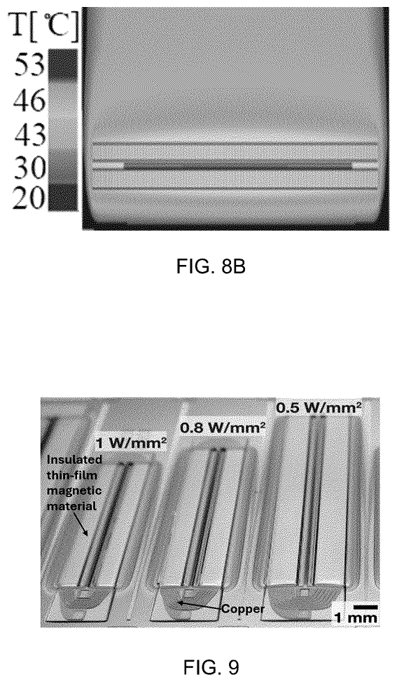

Thermal simulation using ANSYS® Icepak® incorporates the simulated losses as internal heat sources. Natural convection was considered with no external cooling involved. FIG. 8A and FIG. 8B show the resulting thermal profiles of the multiferroic and comparator materials, respectively. As noted above, the multiferroic material had a peak temperature of 44° C., and the comparator material reached a peak temperature of approximately 53° C.

Table II compares the two configurations based on the FEA results. The core losses were nearly identical, confirming that the inclusion of Gd did not penalize electromagnetic efficiency. The 9° C. temperature difference demonstrates the thermal benefit of the proposed multiferroic material for power electronics. While the average temperatures are similar given nearly equivalent losses, the multiferroic material forced the hot spot temperature much closer to the average temperature. The reduced peak temperature enabled the environment of the magnetic device to be warmer or for the losses to be increased while still remaining within a safe operating region. The result is a magnetic device that can be closer to other heat expelling devices and still be within a safe operating condition. In addition, magnetocaloric materials have not yet been reported for use in place of or complementary to soft magnetic materials for this application, and the timing is especially ideal for such exploration.

As demonstrated in the data, a new material structure was developed for magnetic device miniaturization while intrinsically designing an internal solid state thermal management mechanism. A multiferroic material can support the electrical specifications of a converter and use the fundamental physics to its advantage to expel heat. This material is best suited for higher frequency operation and aligns with the future operating conditions of commercial and future semiconductor materials.

1. A self-cooling magnetic device for extracting heat from electromagnetic components, the self-cooling magnetic device comprising:
a soft multiferroic material and a high electrical conductivity, non-magnetic material, wherein the soft multiferroic material is laminated with a high flux density saturation material,
the self-cooling magnetic device having a multilayer structure comprising alternating layers of the laminated soft multiferroic material with layers of the high electrical conductivity, non-magnetic material.

2. The self-cooling magnetic device of claim 1, wherein the soft multiferroic material is a soft magnetocaloric material, a soft electrocaloric material, or a combination thereof.

3. The self-cooling magnetic device of claim 1, wherein the soft multiferroic material is a soft magnetocaloric material having a low permeability above room temperature and thermal conductivity of about 1 W/mK to about 25 W/mK.

4. The self-cooling magnetic device of claim 1, wherein the soft multiferroic material is a soft magnetocaloric material selected from the group consisting of: Gadolinium (Gd), Gd alloys, rare-earth intermetallics, Manganese (Mn) alloys, and other transition metal alloys.

5. The self-cooling magnetic device of claim 1, wherein the soft multiferroic material is a soft electrocaloric material in the form of a thin film.

6. The self-cooling magnetic device of claim 1, wherein the soft electrocaloric material has a thermal conductivity of about 0.1 W/mK to about 5 W/mK.

7. The self-cooling magnetic device of claim 1, wherein the high flux density saturation material is an iron alloy-based material.

8. The self-cooling magnetic device of claim 7, wherein the iron alloy-based material comprises Manganese (Mn), Cobalt (Co), Silicon (Si), Zinc (Zn), or a combination thereof.

9. The self-cooling magnetic device of claim 1, wherein the high electrical conductivity and non-magnetic material is copper, aluminum, silver, titanium, gold, or an alloy thereof.

10. The self-cooling magnetic device of claim 1, wherein the self-cooling magnetic device having a multilayer structure comprises at least two (2) alternated layers of the laminated soft multiferroic material per layer of the high electrical conductivity, non-magnetic material.

11. The self-cooling magnetic device of claim 1, wherein the soft multiferroic material is in the form of a composite, wherein a soft magnetic material is dispersed therethrough as a nanoparticle.

12. The self-cooling magnetic device of claim 11, wherein the soft multiferroic material is a soft magnetocaloric material or a soft electrocaloric material.

13. The self-cooling magnetic device of claim 11, wherein the soft magnetic material is selected from the group consisting of: iron alloy-based materials comprising Manganese (Mn), Cobalt (Co), Silicon (Si), Zinc (Zn), or a combination thereof, and iron nitrides (FeₓN), wherein x is 3 or 4.

14. The self-cooling magnetic device of claim 1, wherein the soft multiferroic material is a soft magnetocaloric material selected from the group consisting of: Gadolinium (Gd), Gd alloys, rare-earth intermetallics, Manganese (Mn) alloys, and other transition metal alloys.

15. A self-cooling multiferroic inductor, the self-cooling multiferroic inductor comprising: a core comprising the self-cooling magnetic device of claim 1; and printed circuit board (PCB)-based, insulated magnet wire, or Litz windings inside the core.

16. The self-cooling multiferroic inductor of claim 15, wherein the self-cooling multiferroic inductor has toroidal or planar core shape.

17. The self-cooling multiferroic inductor of claim 15, wherein the PCB-based or Litz windings comprises copper windings, aluminum windings, silver windings, titanium windings, gold windings, or windings of an alloy thereof.

18. The self-cooling multiferroic inductor of claim 15, wherein the soft magnetic material comprises particles of a magnetic and high permeability iron alloy.

19. A power electronics converter comprising the self-cooling multiferroic inductor of claim 15.

20. A self-cooling multiferroic transformer, the self-cooling multiferroic transformer comprising: a core comprising the self-cooling magnetic device of claim 1; and printed circuit board (PCB)-based, insulated magnet wire, or Litz windings inside the core.
